(19) United States
(12) Patent Application Publication
(10) Pub. No.: US 2025/0185116 A1
(43) Pub. Date: Jun. 5, 2025

(54) SYSTEMS AND METHODS FOR UPLINK TRANSMISSION

(71) Applicant: ZTE CORPORATION, Shenzhen (CN)

(72) Inventors: Xiaolong GUO, Shenzhen (CN); Bo GAO, Shenzhen (CN); Ling YANG, Shenzhen (CN); Yang ZHANG, Shenzhen (CN); Meng MEI, Shenzhen (CN)

(73) Assignee: ZTE CORPORATION, Shenzhen (CN)

(21) Appl. No.: 19/053,608

(22) Filed: Feb. 14, 2025

Related U.S. Application Data
(63) Continuation of application No. PCT/CN2023/107918, filed on Jul. 18, 2023.

(51) Int. Cl. H04W 76/38; H04W 74/0833

(52) U.S. Cl. CPC H04W 76/38; H04W 74/0833

(57) ABSTRACT

Presented are systems and methods for uplink transmission. A wireless communication device can receive, a configuration from a wireless communication node for determining a timing advance (TA) related information between at least two possible approaches. The wireless communication device can perform at least one operation to determine the TA related information according to the configuration.

### CROSS-REFERENCE TO RELATED APPLICATION

This application claims the benefit of priority under 35 U.S.C. § 120 as a continuation of PCT Patent Application No. PCT/CN2023/107918, filed on Jul. 18, 2023, the disclosure of which is incorporated herein by reference in its entirety.

### TECHNICAL FIELD

The disclosure relates generally to wireless communications, including but not limited to systems and methods for uplink transmission.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device (e.g., UE) can receive/obtain/acquire a configuration from a wireless communication node (e.g., BS, gNB, or transmission and reception point (TRP)) for determining a timing advance (TA) related information between at least two possible approaches. The wireless communication device can perform/execute at least one operation to determine the TA related information according to the configuration.

In some implementations, the at least two possible approaches can comprise/include at least one of: a first approach based on a physical random access channel (PRACH) transmission, and/or a second approach based on measurement of downlink (DL) reference signal timing difference (RSTD). In some implementations, the wireless communication device can perform the measurement of DL RSTD according to measurement of at least one DL reference signal (RS).

In some implementations, the at least one DL RS can be configured via a radio resource control (RRC) signaling, and/or associated with at least one synchronization signal block or transmission configuration indicator (TCI) state indicated in a network message. In some implementations, the wireless communication device can determine, according to the configuration, to determine the TA related information based on one of the first approach or the second approach, for a transmission parameter in a time duration.

In some implementations, the time duration can be or comprise at least one of: a symbol, a slot, a sub-slot, a frame, and/or a sub-frame. In some implementations, when receiving the configuration comprises: (a) receiving a configuration to determine the TA related information for a transmission parameter based on the second approach, and (b) receiving an indication to trigger a PRACH transmission for the transmission parameter, the wireless communication device can determine not to transmit the PRACH transmission.

In some implementations, when receiving the configuration comprises: (a) receiving a configuration to determine the TA related information for a transmission parameter based on the second approach, and (b) receiving an indication to trigger a PRACH transmission for the transmission parameter, the wireless communication device can determine to transmit the PRACH transmission. In some implementations, at least one of: the wireless communication device can determine not to determine the TA related information based on the second approach for the transmission parameter in a time duration after the PRACH transmission or after reception of the indication; the wireless communication device can determine not to determine the TA related information based on the second approach for the transmission parameter after the PRACH transmission or after reception of the indication; and/or the wireless communication device can determine not to use the TA related information determined based on the second approach, for the transmission parameter.

In some implementations, the wireless communication device can receive a network message that indicates switching to a transmission parameter; and at least one of: the wireless communication device apply a TA related information indicated by the network message instead of the TA related information determined for the transmission parameter based on the second approach, when the configuration indicates the wireless communication device to determine the TA related information based on the second approach; the wireless communication device can apply the TA related information determined for the transmission parameter based on the second approach, when the wireless communication device is not configured to determine the TA related information using the first approach or when a TA related information is absent in the network message; the wireless communication device can apply the TA related information determined for the transmission parameter based on the second approach, instead of a TA related information indicated by the network message, when the wireless communication device is configured to determine the TA related information based on the second approach; the wireless communication device apply the TA related information indicated by the network message, when the configuration indicates the wireless communication device to determine the TA related information using the first approach; and/or the wireless communication device can apply the TA related information determined for the transmission parameter based on the second approach, when the wireless communication device is configured to determine the TA related information based on the second approach.

In some implementations, the wireless communication device may send/transmit/provide/communicate a message comprising a capability of the wireless communication device. The capability can comprise at least one of: a capability to simultaneously maintain up to a specific number of TA related information (e.g., TA values) determined based on the second approach, a capability to simultaneously perform determinations of TA related information based on the second approach for up to a specific number of transmission parameters, a capability to be simultaneously configured with up to a specific number of synchronization signal blocks (SSBs) or SSB sets, a capability to simultaneously use up to a specific number of SSBs or SSB sets for measurement of at least one of channel or reference signal received power (RSRP), and/or a capability to be simultaneously activated with up to a specific number of SSBs, SSB sets, or transmission configuration indicator (TCI) states.

In some implementations, the wireless communication device can determine, responsive to sending the message, at least one of: that a number of transmission parameters to determine TA related information based on the second approach is to be less than or equal to the specific number of transmission parameters based on the second approach, to determine TA related information based on the second approach for a number of transmission parameters that is to be less than or equal to the specific number of transmission parameters for determining TA related information based on the second approach, that a number of transmission parameters associated with simultaneously activated SSBs, SSB sets, or TCI states, is to be less than or equal to the specific number of transmission parameters for determining TA related information based on the second approach, and/or that a number of simultaneously activated SSBs, SSB sets, or TCI states, is to be less than or equal to the specific number of SSBs, SSB sets, or TCI states.

In some implementations, the wireless communication device can determine that a plurality of PRACH transmissions are associated with a same transmission parameter, a same operation for determining TA related information, and/or a same random access procedure, responsive to at least one of: the plurality of PRACH transmissions are in response to a same network message, the plurality of PRACH transmissions are in response to network messages indicating a same of at least one of: cell indicator, synchronization signal block (SSB) index, random access preamble index, and/or random access channel (RACH) occasion information, and/or the plurality of PRACH transmissions are associated with a same timer, accumulation state, or counter.

In some implementations, the wireless communication device may receive a second configuration indicative of a timer associated with a PRACH transmission, an operation for determining a TA related information, and/or a random access procedure from the wireless communication node via a radio resource control (RRC) signaling. In some implementations, at least one of: the timer starts when the wireless communication device performs a PRACH transmission in response to a network message indicative of a first PRACH transmission associated with a transmission parameter, an operation for determining a TA value, and/or a random access procedure, and/or the timer restarts or resets when the wireless communication device receives a network message indicative of triggering a PRACH transmission associated with the timer and the timer is running or valid, and/or when the wireless communication device transmits a PRACH transmission associated with the timer and the timer is running or valid.

In some implementations, the wireless communication device can determine a transmission power of a PRACH transmission, according to at least one of: a target received power value configured by a radio resource control (RRC) signaling, a pathloss value determined according to a reference signal associated with the PRACH transmission or a network message, a power ramping value configured by the RRC signaling, and/or a counting value.

In some implementations, the wireless communication device can determine the counting value according to at least one of: (1) setting the counting value to an initial value, for the PRACH transmission, in response to a first network message indicative of a first PRACH transmission associated with a first transmission parameter, a operation for determining a timing advance value, or a random access procedure; (2) increasing the counting value by 1, for the PRACH transmission, in response to a second network message indicative of a first PRACH transmission associated with a first transmission parameter, a operation for determining a timing advance value, or a random access procedure, where the second network message may be received after the first network message; (3) increasing the counting value by 1, for the PRACH transmission in response to a third network message that is associated with a first transmission parameter, a operation for determining a timing advance value, or a random access procedure, wherein the third network message is received after the first network message; (4) not increasing the counting value or setting the counting value to a former value, if the wireless communication device has reached a maximum value of transmission power at a time instance of the PRACH transmission; (5) setting the counting value to the initial value, if a timer associated with the PRACH transmission, the operation for determining a TA related information, or the random access procedure, expires; (6) setting the counting value to the initial value, if a timer associated with the PRACH transmission, the operation for determining a timing advance value, or the random access procedure, starts; (7) increasing the counting value by 1, if a timer associated with the PRACH transmission, the operation for determining a timing advance value or the random access procedure, restarts or resets; (8) setting the counting value to the initial value, if the PRACH transmission starts or ends at a symbol or slot later than a time duration from a starting or ending symbol of a previous PRACH transmission, or if the wireless communication device receives the network message associated with the PRACH transmission at a symbol or slot later than a time duration from a symbol or slot of receiving a network message associated with the previous PRACH transmission; and/or (9) resetting the counting value to the initial value, if the wireless device receives a network message specifying a specific value of a target received power for the PRACH transmission.

In some implementations, the wireless communication device can determine a transmission power of a PRACH transmission, according to at least one of: a target received power value configured by a radio resource control (RRC) signaling, a pathloss value determined according to a reference signal associated with the PRACH transmission or a network message, a power ramping value configured by the RRC signaling, and/or an accumulation value of a transmission power ramping.

In some implementations, the wireless communication device can determine the accumulation value according to at least one of: (1) resetting the accumulation value to a defined value, if the PRACH transmission is a first PRACH transmission associated with a transmission parameter, a operation for determining a TA related information, or a random access procedure; (2) resetting the accumulation value to a defined value, if a timer associated with the PRACH transmission, the operation for determining a TA related information, or the random access procedure, expires; (3) resetting the accumulation value to a defined value, if a timer associated with the PRACH transmission, the operation for determining a TA related information, or the random access procedure, starts; (4) a transmission power or target received power of a previous PRACH transmission, if a timer associated with the PRACH transmission, the operation for determining a TA related information, or the random access procedure, restarts or resets; (5) a transmission power of a previous PRACH transmission, wherein the previous PRACH transmission is associated with a same transmission parameter, operation for determining a TA related information or the random access procedure, as the PRACH transmission; (6) an accumulated target received power of a previous PRACH transmission, wherein the accumulated target received power is determined based on a target received power value configured by a radio resource control (RRC) signaling and a power ramping value configured by the RRC signaling, wherein the previous PRACH transmission is associated with a same transmission parameter, operation for determining a TA related information or the random access procedure, as the PRACH transmission; (7) an accumulation value of PRACH transmission power ramping for a previous PRACH transmission, if UE has reached a maximum value of transmission power at a time instance of the PRACH transmission, wherein the previous PRACH transmission is associated with a same transmission parameter, operation for determining a TA related information or the random access procedure, as the PRACH transmission; (8) resetting the accumulation value to a defined value, if the PRACH transmission starts or ends at a symbol or slot later than a time duration from a starting or ending symbol of a previous PRACH transmission, or if the wireless communication device receives the network message associated with the PRACH transmission at a symbol or slot later than a time duration from a symbol or slot of receiving a network message associated with the previous PRACH transmission, wherein the previous PRACH transmission is associated with a same transmission parameter, operation for determining a TA related information or the random access procedure, as the PRACH transmission; and/or (9) resetting the accumulation value to a defined value, if the wireless communication device receives a network message specifying a specific value of a target received power for the PRACH transmission, wherein the wireless communication device determines a transmission power of the PRACH transmission based on the specific value of the target received power rather than a target received power value configured by RRC signaling.

In some implementations, the transmission parameter can comprise at least one of: a candidate cell, a non-serving cell, a serving cell index different from one associated with a serving cell, a physical cell identifier (PCI) different from one associated with the serving cell, a timing advance group (TAG) associated with a specific control resource set (CORESET) pool index, a cell or transmission-reception point (TRP) not associated with Type-1 common search space (CSS), a TRP, a base station or wireless communication node, a set of panels of one base station, a cell, a physical cell, information grouping one or more reference signals, a reference signal resource set, a physical uplink control channel (PUCCH) resource set, a search space, panel related information, a sub-array, an antenna group, an antenna port group, a group of antenna ports, a beam group, a PCI, TRP related information, a CORESET, a CORESET pool, a transmission configuration indicator (TCI) state, a serving cell, an additional PCI, a candidate cell group, TAG, a UE capability value, and/or a UE capability set.

At least one aspect is directed to a system, method, apparatus, or a computer-readable medium. A wireless communication node can send a configuration from a wireless communication device for determining a timing advance (TA) related information between at least two possible approaches. The wireless communication device can perform at least one operation to determine the TA related information according to the configuration.

The systems and methods presented herein include a novel approach for uplink transmission. Specifically, the systems and methods presented herein discuss a novel solution for the UE to determine transmission power, timing advance (TA) related information (e.g., TA value), and/or indicate capabilities for uplink transmissions. The systems and methods can define counting-based and/or accumulation-based configurations for determining the transmission power of PRACH, such as when triggered by a network message, defining TA value determination based on or according to the measurement of a downlink reference signal, and/or defining the UE indicating a capability related to TA value determination.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure; and

FIG. 3 illustrates a flow diagram of an example method for uplink transmission, in accordance with an embodiment of the present disclosure.

### DETAILED DESCRIPTION

### 1. Mobile Communication Technology and Environment

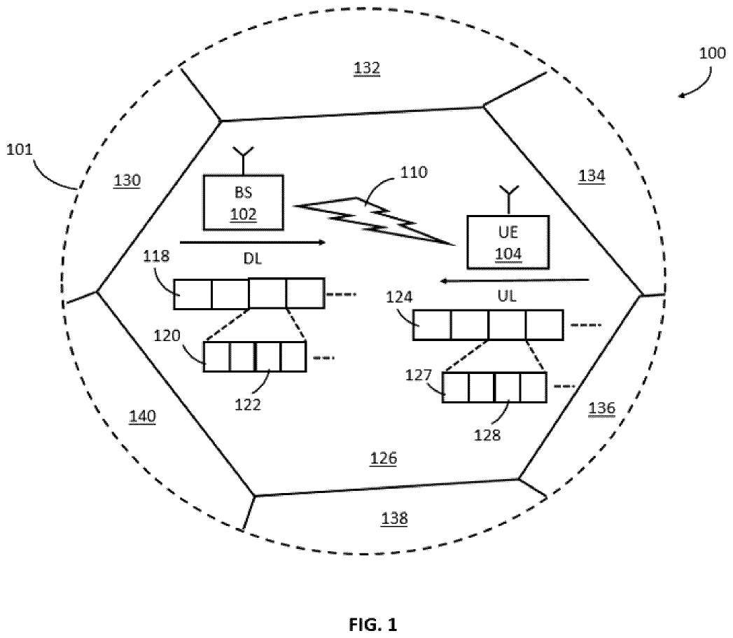

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

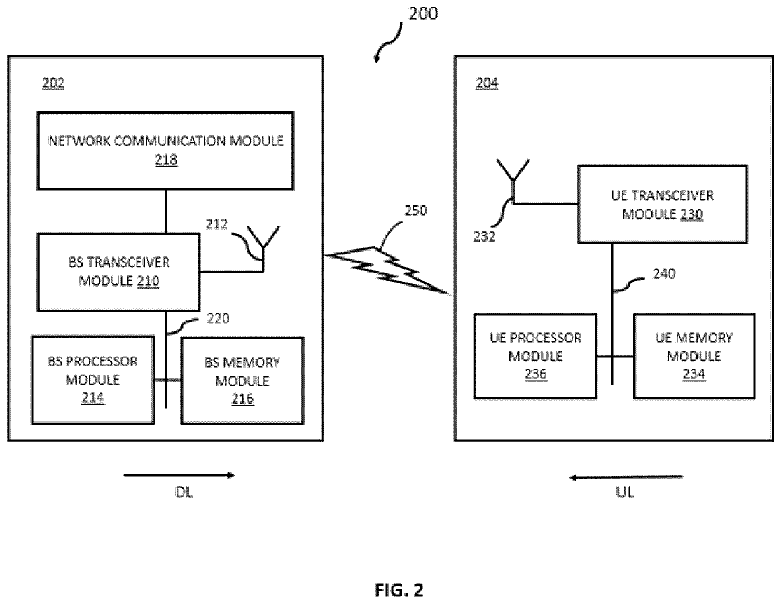

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Uplink Transmission

Downlink and uplink synchronization can ensure or enable reliable wireless communication in various wireless communication systems. In certain scenarios, downlink synchronization can be achieved, performed, or realized by receiving the primary synchronization signal (PSS) and secondary synchronization signal (SSS), and the uplink synchronization can be achieved by random access procedure and uplink timing alignment maintenance. The uplink timing alignment maintenance may be based on timing advance command (TAC) transmitted/provided/sent/broadcasted by the network (e.g., BS 102).

In some cases, a 4-step type random access procedure can include physical random access channel (PRACH) transmission, random access response (RAR) reception, Msg3 transmission, and/or contention resolution reception. For a random access procedure triggered by a PDCCH order, PRACH transmission and/or RAR reception may be included in the random access procedure. In the specification, PRACH transmission power can be determined as P_{PRACH}=min {P_{CMAX}, P_{PRACH,target}+PL}, where P_{PRACH,target} can denote or represent the PRACH target reception power provided by higher layers, and PL can denote a pathloss based on the downlink (DL) reference signal (RS) associated with the PRACH transmission.

In some cases, when the PRACH transmission is not received by the network, the UE 104 may not receive the corresponding RAR message and re-transmit the PRACH, for example. The PRACH target reception power for the retransmission of the PRACH can be determined by higher layers based on a counter. In positioning, the UE 104 may indicate its capability for measurement of downlink reference signal time difference (DL RSTD), and perform the measurement based on downlink PRS resources configured by the network. The PRS resources can be regarded/referred to as a type of channel state information (CSI)-RS.

The DL RSTD can include or reflect the downlink transmission delay difference between different transmission points. The DL RSTD can be used/utilized to determine or estimate the uplink transmission delay difference between different transmission points. In some cases, uplink timing advance value determination can be requested when CSI-RS resources are not configured to the UE 104 and/or CSI-RS resources may not be transmitted. As such, the downlink reference signals for measurement can be synchronization signal (SS)/physical broadcast channel (PBCH) blocks.

Uplink synchronization can be performed at least after downlink synchronization, because PRACH transmission, SRS transmission, and/or downlink reference signal measurement are based on downlink timing and/or downlink signals. In cases of cell switching, downlink synchronization of one or multiple cells can be performed. Subsequently, uplink synchronization of the multiple cells can be performed. The UE 104 may report to the network (e.g., BS 102) a message based on or according to the downlink synchronization of multiple cells. In some cases, the UE 104 may receive a message (e.g., network message) indicating a subset of the multiple cells. In some cases, the network message may indicate or include the index of the cells, SSB associated with the cells, and/or transmission configuration indicator (TCI) states associated with the cells.

In certain systems, PRACH transmission can be triggered/initiated for beam failure recovery, initial access, uplink synchronization, positioning, uplink time alignment, etc. PRACH transmission can be triggered by the UE 104 via predefined/predetermined triggering events and/or by the network (e.g., BS 102) via downlink control information (DCI) format for PDCCH order, among other triggering conditions/events. In some cases, random access response may not be transmitted by the BS 102. In such cases, the transmission power determination for PRACH transmission based on a counter in medium access control (MAC) layer may not be applied. Hence, it may be desired for improvements (or new configurations) for determining PRACH transmission power.

In some configurations, both a RACH-based approach/method and DL RSTD-based method can be configured for the UE 104 to acquire at least one timing advance (TA) value. The UE 104 may be indicated or configured to perform at least one of the methods (e.g., RACH-based method or DL RSTD-based method) at a certain time instance. The systems and methods can include features or operations discussed herein to provide or achieve co-existence for these methods.

In some configurations, the UE 104 can be requested to acquire timing advance values for multiple cells. For DL RSTD-based method, the UE 104 may perform measurement of downlink reference signals for multiple cells. With an increase in the number of cells (e.g., for the multiple cells), the processing complexity can increase/be larger. In this case, the corresponding UE capabilities can be indicated to the network.

In some implementations, the UE 104 may perform uplink synchronization of multiple cells based on a network message in response to the UE 104 performing downlink synchronization of multiple cells. The configuration of uplink synchronization may be based on the network message.

In various arrangements, as discussed herein, a transmission parameter may include/comprise (e.g., an indication of) at least one of: a transmit receive point (TRP), the BS 102 (or the network), a set of panels of one BS, a cell, and/or a physical cell, among others. In some cases, the transmission parameter may include at least one of: information grouping one or more reference signals, reference signal resource set, PUCCH resource set, search space, panel-related information, sub-array, antenna group, antenna port group, group of antenna ports, beam group, physical cell index (PCI), TRP related information, CORESET, CORESET pool, transmission configuration indicator (TCI) state, serving cell, additional PCI, candidate cell, candidate cell group, time alignment group (TAG), UE capability value, and/or UE capability set, among others.

In some implementations, a candidate cell can correspond to or include at least one of non-serving cell, target cell, and/or neighbor cell. In some implementations, the uplink transmission may include or correspond to a transmission occasion of an uplink signal, a repetition of an uplink signal, and/or an uplink signal. The uplink signal can include or be PUCCH, physical uplink shared channel (PUSCH), sounding reference signal (SRS), and/or physical random access channel (PRACH). In some implementations, a downlink reference signal (DL-RS) can include or be at least one of channel state information (CSI) reference signal (RS) and/or synchronization signal block (SSB), among other signalings. The SSB can include or correspond to SS and/or PBCH block. In some arrangements, timing advance-related information can include at least one of: a TAG index, a timing advance value, a timing advance command, a timing advance offset, and/or a timing advance offset command.

In some cases, the timing advance command may indicate to the UE 104 an adjustment value (e.g., another value) for the timing advance value. The timing advance offset may be configured for a transmission parameter to adjust uplink transmission timing. The timing advance offset command can be used to indicate the timing advance adjustment offset value between TACs and/or TA values. In some implementations, timing advance acquisition can correspond to uplink timing alignment. The PRACH transmission may correspond to a random access preamble transmission, an Msg1 transmission, and/or a MsgA transmission.

### Example Implementation 1: UE Determines Transmission Power of a PRACH Transmission

In various implementations, the UE 104 can determine the transmission power of a PRACH transmission in response to receiving a network message indicating to trigger a PRACH transmission associated with a transmission parameter. The UE 104 can be configured or indicated to not receive a network message in response to the PRACH transmission.

In some implementations, the UE 104 may receive/obtain/acquire a network message indicative of triggering/initiating/activating a PRACH transmission associated with a transmission parameter, timing advance acquisition procedure, and/or random access procedure. The UE 104 may transmit a PRACH transmission in response to receiving the network message. The network message can include or correspond to at least a DCI format for PDCCH order. The network message may indicate at least one of random access preamble index, SS/PBCH block index, RACH occasion information, cell indicator, and/or retransmission indicator, among others. The UE 104 may transmit/send/communicate/provide/forward the PRACH transmission to the BS 102 based on at least one indication field in the network message.

In some implementations, the transmission parameter can include at least one of: a candidate cell, a non-serving cell, a serving cell index different from the serving cell index associated with the serving cell, a PCI different from the PCI associated with the serving cell, a TAG associated with a specific CORESET pool index, a cell/TRP not associated with Type-1 CSS, etc. In some implementations, the UE 104 may consider or determine that the PRACH transmissions satisfy at least one of the following:
(1) PRACH transmissions may be in response to the same network message;
(2) PRACH transmissions may be in response to one or more network messages indicating the same of at least one of the following: cell indicator, synchronization signal block (SSB) index (e.g., SSB index), random access preamble index, and/or RACH occasion information, among others; and/or
(3) PRACH transmissions may be associated with the same timer, accumulation state, and/or counter. In some cases, the PRACH transmissions may be associated with the same transmission parameter, a same operation for determining TA values (e.g., timing advance acquisition procedure), and/or random access procedure, etc.

In some implementations, the UE 104 may receive/obtain a configuration (e.g., a second configuration) from the BS 102 via/from/through at least one type of signaling, such as RRC signaling, among others. The configuration can be indicative of a timer associated with a PRACH transmission, timing advance acquisition procedure (e.g., an operation for determining a TA value), and/or random access procedure, among others. In some cases, the timer can start/initiate/begin when the UE 104 performs a PRACH transmission in response to a network message indicative of a first/initial PRACH transmission associated with a transmission parameter, timing advance acquisition procedure, and/or random access procedure.

In some cases, the timer may restart/reset at least one of: when the UE 104 receives a network message indicative of triggering a PRACH transmission associated with the timer and the timer is ongoing/running/valid, and/or when the UE 104 transmits a PRACH transmission associated with the timer and the timer is ongoing/running/valid, for example.

### Example Aspect 1 of Example Implementation 1

In various aspects, the UE 104 may determine the transmission power of the PRACH transmission based on at least one of a target received power value configured by RRC signaling (or other types of signalings), a pathloss value determined based on a reference signal associated with the PRACH transmission or the network message, a power ramping value configured by RRC signaling, and/or a counting value, to name a few. The counting value can start at/from 0 or 1. The UE 104 may determine the counting value for PRACH transmission power determination according to or based on at least one of the following:
(1) Set/configure a counting value to an initial value, such as 0 or 1 depending on the configuration or pre-definition, for a PRACH transmission, in response to a network message (e.g., first network message) indicative of a first/initial PRACH transmission associated with a transmission parameter (e.g., first transmission parameter), a timing advance acquisition procedure (e.g., a first operation for determining a timing advance value), and/or a random access procedure (e.g., first random access procedure), and/or in response to a first received network message associated with a transmission parameter, a timing advance acquisition procedure, and/or a random access procedure.
(2) Increase the counting value by 1, for the PRACH transmission, in response to a network message (e.g., a second network message) indicative of a PRACH transmission after the first/initial PRACH transmission associated with a transmission parameter, a timing advance acquisition procedure, and/or a random access procedure.
(3) Increase the counting value by 1, for the PRACH transmission, in response to a network message (e.g., a third network message) associated with a transmission parameter, a timing advance acquisition procedure, and/or a random access procedure.
(4) Not increase or maintain the counting value or set the counting value to a former/previous counting value, if the UE 104 has reached a maximum value of transmission power at the time instance of the PRACH transmission. The maximum value of transmission power can be configured or predefined for a carrier component, a SRS resource set, a power class, a panel, a TCI state, etc. The time instance can be a transmission occasion, a slot, and/or a symbol.
(5) Set the counting value to the initial value of 0 or 1, if a timer associated with the PRACH transmission, timing acquisition procedure, and/or random access procedure expires/timeout.
(6) Set the counting value to the initial value (e.g., 0 or 1), if a timer associated with the PRACH transmission, timing advance acquisition procedure, and/or random access procedure starts.
(7) Increase the counting value by 1, if a timer associated with the PRACH transmission, timing acquisition procedure, and/or random access procedure restarts/resets.
(8) Set the counting value to the initial value (e.g., 0 or 1), if the PRACH transmission starts or ends at a symbol/slot later than a time duration from the starting or ending symbol of a previous/prior PRACH transmission, or if the UE 104 receives the network message associated with the PRACH transmission at a symbol/slot later than a time duration from a symbol/slot of receiving a network message associated with a previous PRACH transmission. The time duration can be a predefined value, an RRC configured value, a fixed value, and/or a value based on the UE capability, among others. The time duration can be in a unit of millisecond, symbol, slot, sub-slot, frame, or sub-frame, etc. The previous PRACH transmission may be associated with the same transmission parameter, timing advance acquisition procedure, and/or random access procedure as the (e.g., current) PRACH transmission.
(9) Reset the counting value to the initial value (e.g., 0 or 1), if the UE 104 receives a network message configuring/indicating a specific value of the target received power for PRACH transmission. The UE 104 can determine the transmission power of the PRACH transmission based on or according to the specific value of the target received power, for instance, instead of or rather than the target received power value configured by or via the RRC signaling, among other types of signalings.

In various implementations discussed herein, the operation regarding or on the counting value can be associated with a counter. For example, the UE 104 can determine the transmission power of a PRACH transmission based on or according to the following example formula: P_{PRACH}=P_{target}+PL+(COUNT−C₀)*P_{ramping}, where P_{target} can represent the target received power value, PL can represent the calculated pathloss value, COUNT can represent the counting value, C₀ can represent the initial value of the counting value, and P_{ramping} can represent the power ramping value. In some cases, other formulas or techniques can be utilized to perform similar computations.

In further examples, the UE can determine the transmission power of a PRACH transmission based on or according to the following example formula, P_{PRACH}=P_{target,1}+PL, where P_{target,1}=P_{target}+(COUNT−C₀)*P_{ramping}, P_{target} can represent the target received power value, PL can represent the calculated pathloss value, COUNT can represent the counting value, C₀ can represent the initial value of the counting value, P_{ramping} can represent the power ramping value, and P_{target,1} can represent the target received power with power ramping.

### Example Aspect 2 of Example Implementation 1

In some implementations, the UE 104 can determine the transmission power of the PRACH transmission based on or according to at least one of: a target received power value configured by/via RRC signaling (or other types of signalings), a pathloss value determined based on a reference signal associated with the PRACH transmission or the network message, a power ramping value configured by RRC signaling, and/or an accumulation value of PRACH transmission power ramping. The UE 104 may determine the accumulation value of PRACH transmission power ramping for the PRACH transmission as in at least one of the following:
(1) If the PRACH transmission is an initial/first PRACH transmission associated with a transmission parameter (e.g., a first transmission parameter), a timing advance acquisition procedure (e.g., a first operation for determining a timing advance value), and/or a random access procedure (e.g., first random access procedure), the accumulation value of PRACH transmission power ramping can correspond to 0 or the UE 104 may reset the accumulation value of PRACH transmission power ramping to zero.
(2) If a timer associated with the PRACH transmission, the timing acquisition procedure, and/or the random access procedure expires, the accumulation value of PRACH transmission power ramping can be set to or correspond to 0 or the UE 104 can reset the accumulation value of PRACH transmission power ramping to zero.
(3) If a timer associated with the PRACH transmission/timing advance acquisition procedure/random access procedure starts, the accumulation value of PRACH transmission power ramping can be set to 0 or the UE 104 can reset the accumulation value of PRACH transmission power ramping to zero.
(4) If a timer associated with the PRACH transmission, timing advance acquisition procedure, and/or random access procedure, restarts or resets, the UE 104 can determine the accumulation value of PRACH transmission power ramping for the PRACH transmission according to or based on transmission power and/or target received power of the previous PRACH transmission.
(5) The UE 104 can determine the accumulation value of PRACH transmission power ramping for the PRACH transmission according to the transmission power of the previous PRACH transmission, where the previous PRACH transmission may be associated with the same transmission parameter, timing advance acquisition procedure, and/or random access procedure as the (e.g., current or subsequent) PRACH transmission.
(6) The UE 104 can determine the accumulation value of PRACH transmission power ramping according to an accumulated target received power of the previous PRACH transmission, where the accumulated target received power may be determined based on a target received power value configured or indicated by the RRC signaling and a power ramping value configure by RRC signaling, and the previous PRACH transmission may be associated with the same transmission parameter, timing advance acquisition procedure, and/or random access procedure as the PRACH transmission.
(7) If the UE 104 reached a maximum value of transmission power at the time instance of the PRACH transmission, the UE 104 can determine the accumulation value of PRACH transmission power ramping to correspond to or be the same as the accumulation value of PRACH transmission power ramping for the previous PRACH transmission. The maximum value of transmission power can be configured or predefined for a carrier component, an SRS resource set, a power class, a panel, and/or a TCI state, etc. The time instance can include or be a transmission occasion, a slot, and/or a symbol. The previous PRACH transmission may be associated with the same transmission parameter, timing advance acquisition procedure, and/or random access procedure as the PRACH transmission.
(8) If the PRACH transmission starts or ends at a symbol/slot later than or after a time duration from the starting or ending symbol of a previous PRACH transmission, or if the UE 104 receives the network message associated with the PRACH transmission at a symbol/slot later than a time duration from a symbol/slot of receiving a network message associated with a previous PRACH transmission, the accumulation value of PRACH transmission power ramping can be 0 or the UE 104 may reset the accumulation value of PRACH transmission power ramping to zero. The time duration can be a predefined value, an RRC-configured value, a fixed value, or a value based on the UE capability, etc. The time duration can be in a unit of but not limited to a millisecond, symbol, slot, sub-slot, frame, and/or sub-frame. The previous PRACH transmission may be associated with the same transmission parameter, timing advance acquisition procedure, and/or random access procedure as the PRACH transmission.
(9) The UE 104 may reset/restart the accumulation value of PRACH transmission power ramping to zero, for instance, if the UE 104 receives a network message configuring/indicating a specific value of target received power for PRACH transmission. The UE 104 may determine the transmission power of the PRACH transmission according to a specific value of the target received power, for instance, rather than the target received power value configured by RRC signaling (or other types of signalings).

In various implementations, operations or features on the accumulation value can be associated with an accumulation state. For example, the UE 104 can determine the transmission power of a PRACH transmission based on the following example formula, P_{PRACH}=P_{target, accumulated}+PL, wherein P_{target, accumulated} represents the accumulated target received power value, PL represents the calculated pathloss value.

In further examples, the UE 104 can determine the transmission power of a PRACH transmission according to the following example formula, P_{PRACH}=P_{accumulation}+PL+P_{ramping}, where P_{accumulation} can represent the accumulation value of PRACH transmission power, PL can represent the calculated pathloss value, and P_{ramping} can represent the power ramping value. In yet another example, the UE 104 may determine the transmission power of a PRACH transmission based on the following example formula, P_{PRACH}=P_{accumulation}+P_{ramping}, where P_{accumulation} can represent the accumulation value of PRACH transmission power, and P_{ramping} can represent the power ramping value. In some other implementations, the UE 104 may utilize other example formulas to determine the transmission power of the PRACH transmission, not limited to those herein.

In some embodiments, the UE 104 can determine the transmission power of the PRACH transmission to be a minimum value (e.g., lowest value) between a maximum power value (or limitation) and the transmission power determined according to at least one of the example implementations for determining the transmission power. The maximum power value can be configured/predefined/fixed for a carrier, a cell, a transmission occasion, and/or a time instance, among other variables.

### Example Implementation 2: UE Determines a Timing Advance Value for an Uplink Transmission based on a Measurement of a Downlink Reference Signal

In various implementations, the UE 104 can determine a timing advance value for an uplink transmission according to or based on a measurement of a downlink reference signal. In some cases, prior to or before the UE 104 determines the timing advance value for an uplink transmission based on a measurement, the UE 104 can report/indicate/signal to the BS 102 a capability (e.g., of the UE 104) to support the timing advance determination according to a measurement. Responsive to the reporting/indication, the UE 104 may receive/obtain a configuration from the BS 102 allowing/enabling/indicating that the UE 104 to perform timing advance determination for a transmission parameter according to the measurement. The UE 104 can utilize the configuration to obtain the TA value, for instance, between multiple approaches (e.g., PRACH and/or DL RSTD, etc.) as discussed herein.

In some implementations, the measurement can be based on the UE 104 receiving one or more downlink reference signal(s). The UE 104 can determine a first time of the UE 104 receiving the start of a sub-slot/slot/frame/subframe from a first transmission parameter and determine a second time of the UE 104 receiving the start of a sub-slot/slot/frame/subframe from a second transmission parameter. The sub-slot/slot/frame/subframe from the second transmission parameter can be the closest in time to the sub-slot/slot/frame/subframe from the first transmission parameter. The UE 104 can determine a timing difference between the first transmission parameter and the second transmission parameter according to the first and second time of the UE 104 receiving the start of a sub-slot/slot/frame/subframe. The one or more downlink reference signal(s) can include or be at least one of SS/PBCH blocks, PRS, and/or CSI-RS, among others. When the UE 104 performs timing advance determination for a transmission parameter based on the measurement, the transmission parameter can be the first transmission or the second transmission.

In some implementations, the UE 104 can perform the measurement of DL RSTD according to or based on the downlink reference signal(s) (RS) configured by or via the RRC signaling (or other types of signalings) for timing advance acquisition for the transmission parameter, and/or the downlink reference signal(s) associated with SS/PBCH blocks and/or TCI states indicated in a network message. The indicated SS/PBCH blocks and/or TCI states may be associated with the transmission parameter. The network message can include or be a MAC CE (or other signalings). For example, the UE 104 can receive a MAC CE indicating to activate an SS/PBCH block or a TCI state, where the activated SS/PBCH block or the activated TCI state can be associated with a transmission parameter. The UE 104 can perform uplink timing advance acquisition for the transmission parameter according to the measurement of the activated SS/PBCH block or the SS/PBCH block associated with the activated TCI state.

In some implementations, the UE 104 may not expect to be configured/indicated/enabled to perform PRACH transmission/random access procedure/random access procedure without RAR and the measurement (e.g., DL RSTD) simultaneously, for a transmission parameter in (e.g., within/during/at) a time duration. For instance, in this case, the UE 104 can determine, according to the configuration from the BS 102, to determine the TA value based on one of the approaches (e.g., first approach, such as PRACH, or second approach, such as DL RSTD) for a transmission parameter. The time duration or time instance can be a symbol, slot, sub-slot, frame, and/or sub-frame.

In some implementations, the UE 104 may not transmit (or determine not to transmit) a PRACH transmission (e.g., the first approach), such as when the UE 104 receives the configuration allowing/enabling/indicating for the UE 104 to perform timing advance determination for a transmission parameter according to a measurement (e.g., DL RSTD or the second approach) from the RRC signaling (or other types of signalings) (e.g., receiving a configuration to determine the TA value for a transmission parameter based on the second approach), and/or when the UE 104 receives a network message indicating to trigger a PRACH transmission for the transmission parameter.

In some implementations, when the UE 104 receives the configuration to be allowed/enabled/indicated to perform timing advance determination (e.g., configuration to determine the TA value) for a transmission parameter based on a measurement (e.g., DL RSTD) from RRC signaling, the UE 104 can send a PRACH transmission when the UE 104 receives a network message indicating to trigger a PRACH transmission for the transmission parameter. In some cases, the UE 104 may perform at least one of the following:
(1) The UE 104 may not perform timing advance determination (e.g., determine not to determine the TA value) based on or according to the measurement (e.g., the second approach) for the transmission parameter in a time duration after the PRACH transmission or the reception of the network message. The time duration can be a predefined value, a fixed value, and/or a RRC configured value. The time duration can be in a unit of a millisecond, symbol, slot, sub-slot, frame, or sub-frame, among others.
(2) The UE 104 may not perform timing advance determination based on the measurement for the transmission parameter after the PRACH transmission or the reception of the network message.
(3) The UE 104 may clear/ignore/invalidate the timing advance-related information for the transmission parameter determined based on or according to the measurement.

In some implementations, the UE 104 may receive a network message indicating switching to/towards a transmission parameter. The network message can be or correspond to a MAC CE and/or a DCI format, etc. For example, there may be a conflict in the values obtained using measurement (e.g., UE 104 already obtained the TA value via measurement) and the BS 102 indicated another TA value in the network message). In such case, the UE 104 may perform at least one of the following:
(1) The UE 104 can apply the timing advance-related information (e.g., TA value) indicated by or in the network message instead of or rather than the TA value determined based on the measurement (e.g., the second approach or DL RSTD) to determine the TA value for uplink transmissions associated with the transmission parameter when the UE 104 is configured to perform timing advance acquisition based on PRACH transmission (e.g., first approach) or the measurement.
(2) The UE 104 may apply the TA value determined based on the measurement (e.g., second approach) to determine the TA value, e.g., for uplink transmissions associated with the transmission parameter when the TA value is absent (or not present/indicated) in the network message and/or when the UE 104 is not configured to perform timing advance acquisition based on PRACH transmission.
(3) The UE 104 may apply the TA value determined based on the measurement rather than that indicated in the network message to determine the TA value for uplink transmissions associated with the transmission parameter when the UE 104 is configured to perform timing advance-acquisition based on the PRACH transmission or the measurement.
(4) The UE 104 may apply the TA value indicated in or by the network message to determine the TA value for uplink transmissions associated with the transmission parameter, such as when the UE 104 is configured to perform timing advance acquisition based on PRACH transmission.
(5) The UE 104 can apply the TA value determined based on or for the measurement to determine the TA value for uplink transmissions associated with the transmission parameter when the UE 104 is configured to perform timing advance acquisition based on the measurement (e.g., the second approach).

### Example Implementation 3: Specify UE Capabilities for Uplink Transmission

In various implementations, the UE 104 can provide its capability (or an indication of its capability) related to or to support the TA value determination for uplink transmission. For example, the UE 104 may indicate or send a message including a capability of the UE 104 for a number of TA values that the UE 104 can simultaneously/concurrently maintain/keep based on or according to the measurement of downlink reference signal(s). In some cases, the UE 104 can indicate a capability for a (e.g., specific) number of transmission parameters that the UE 104 can be simultaneously configured to perform timing advance acquisition based on the measurement of downlink reference signal(s). In some cases, the UE 104 can indicate a capability for a number of SS/PBCH blocks (e.g., SSBs) and/or a number of SS/PBCH block sets (e.g., SSB sets) that the UE 104 can be simultaneously configured. In some aspects, the UE 104 can indicate a capability for a number of SS/PBCH blocks that the UE 104 can simultaneously use for channel measurement and/or RSRP measurement. In some other cases, the UE 104 can indicate a capability for a number of SS/PBCH blocks, SS/PBCH block sets, and/or TCI states that the UE 104 can be activated simultaneously.

In some configurations, in response to the UE 104 indicating the capability (e.g., sending the message to the BS 102), the UE 104 may not expect to be configured with the number of transmission parameters to perform timing advance acquisition that is greater/larger than the capability. In some cases, responsive to the UE 104 indicating the capability, the UE 104 may not expect to be indicated to perform timing advance acquisition for a number of transmission parameters exceeding the capability. In some aspects, the UE 104 may not expect the number of transmission parameter associated with the simultaneously activated SS/PBCH blocks, SS/PBCH block sets, and/or TCI states to be larger than the capability of the UE 104. In some other cases, the UE 104 may not expect the number of simultaneously activated SS/PBCH blocks, and/or TCI states to be larger than the capability.

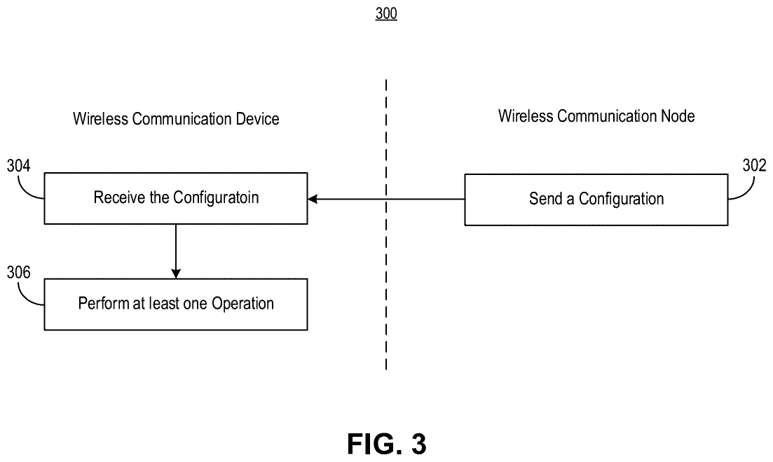

FIG. 3, is a flow diagram illustrating an example method 300 for uplink transmission. The method 300 may be implemented using or performed by any of the components detailed above, such as the UE 104 or 204 and BS 102 or 202, among others. In overview, a wireless communication node can send a configuration to a wireless communication device, at operation 302. At operation 304, the wireless communication device can receive the configuration from the wireless communication node. At operation 306, the wireless communication device can perform at least one operation.

In further detail, at operation 302, a wireless communication node (e.g., BS, gNB, or TRP) can send a configuration for determining a timing advance (TA) related information between at least two possible approaches to a wireless communication device (e.g., UE). At operation 304, the wireless communication device can receive the configuration for determining the TA related information between at least two possible approaches from the wireless communication node. The two approaches can include a first approach (e.g., method, technique, or aspect) and a second approach, although other approaches may be utilized herein.

At operation 306, responsive to or subsequent to receiving the configuration from the wireless communication node, the wireless communication device can perform at least one operation (e.g., of the two possible approaches) to determine the TA related information (e.g., TA value) according to the configuration. In some implementations, the at least two possible approaches can include, but are not limited to, at least one of: a first approach based on a physical random access channel (PRACH) transmission, and/or a second approach based on measurement of downlink (DL) reference signal timing difference (RSTD).

In some implementations, the wireless communication device can perform the measurement of DL RSTD according to measurement of at least one DL reference signal (RS). In some implementations, the at least one DL RS can be configured via a radio resource control (RRC) signaling, or associated with at least one synchronization signal block and/or transmission configuration indicator (TCI) state indicated in a network message.

In some implementations, the wireless communication device may determine, according to the configuration, to determine the TA related information using, based on, or according to one (e.g., not simultaneously) of the first approach or the second approach, for a transmission parameter in a time duration, e.g., for a specific value of a transmission parameter or for a specific transmission parameter. In some implementations, the time duration may be or comprise at least one of: a symbol, a slot, a sub-slot, a frame, and/or a sub-frame, etc.

In some implementations, when receiving the configuration comprises: (a) receiving a configuration to determine the TA related information for a transmission parameter based on the second approach (e.g., DL RSTD measurement), and (b) receiving an indication to trigger a PRACH transmission for the transmission parameter, the wireless communication device can determine not to transmit the PRACH transmission. In some configurations, when receiving the configuration comprises: (a) receiving a configuration to determine the TA related information for a transmission parameter based on the second approach (e.g., DL RSTD measurement), and (b) receiving an indication to trigger a PRACH transmission for the transmission parameter, the wireless communication device may determine to transmit the PRACH transmission, for example.

In some cases, the wireless communication device may determine at least one of: not to determine the TA related information based on the second approach for the transmission parameter in a time duration after the PRACH transmission or after reception of the indication; not to determine the TA related information based on the second approach for the transmission parameter after the PRACH transmission or after reception of the indication; and/or not to use the TA related information determined based on the second approach, for the transmission parameter.

In some implementations, the wireless communication device may receive/obtain/acquire a network message (e.g., from the wireless communication node) that indicates switching to (or acquiring) a transmission parameter (e.g., same or different transmission parameter). In such cases, the wireless communication device can apply at least one of: a TA related information indicated by the network message instead of the TA related information determined for the transmission parameter based on the second approach, when the configuration indicates the wireless communication device to determine the TA related information based on the second approach; the TA related information determined for the transmission parameter based on the second approach, when the wireless communication device is not configured to determine the TA related information using the first approach or when a TA related information is absent in the network message; the TA related information determined for the transmission parameter based on the second approach, instead of a TA related information indicated by the network message, when the wireless communication device is configured to determine the TA related information based on the second approach; the TA related information indicated by the network message, when the configuration indicates the wireless communication device to determine the TA related information using the first approach; and/or the TA related information determined for the transmission parameter based on the second approach, when the wireless communication device is configured to determine the TA related information based on the second approach.

In some implementations, the wireless communication device may send/transmit/provide/communicate/forward a message comprising a capability of the wireless communication device to the wireless communication node. The capability can comprise/include at least one of: a capability to simultaneously maintain up to a specific number of TA related information determined based on the second approach, a capability to simultaneously perform determinations of TA related information based on the second approach for up to a specific number of transmission parameters, a capability to be simultaneously configured with up to a specific number of synchronization signal blocks (SSBs) or SSB sets, a capability to simultaneously use up to a specific number of SSBs or SSB sets for measurement of at least one of channel or reference signal received power (RSRP), and/or a capability to be simultaneously activated with up to a specific number of SSBs, SSB sets, or transmission configuration indicator (TCI) states, among others.

In some implementations, the wireless communication device may determine (or expect), responsive to sending the message, at least one of: that a number of transmission parameters to determine TA related information based on the second approach is to be less than or equal to the specific number of transmission parameters based on the second approach, to determine TA related information based on the second approach for a number of transmission parameters that is to be less than or equal to the specific number of transmission parameters for determining TA related information based on the second approach, that a number of transmission parameters associated with simultaneously activated SSBs, SSB sets, and/or TCI states, is to be less than or equal to the specific number of transmission parameters for determining TA related information based on the second approach, and/or that a number of simultaneously activated SSBs, SSB sets, or TCI states, is to be less than or equal to the specific number of SSBs, SSB sets, or TCI states.

In some aspects, the wireless communication device can determine that a plurality of PRACH transmissions are associated with the same transmission parameter, the same operation for determining TA related information, and/or the same random access procedure, responsive to at least one of: the plurality of PRACH transmissions are in response to a same network message, the plurality of PRACH transmissions are in response to network messages indicating a same of at least one of: cell indicator, synchronization signal block (SSB) index, random access preamble index, and/or random access channel (RACH) occasion information, and/or the plurality of PRACH transmissions are associated with a same timer, accumulation state, and/or counter.

In some implementations, the wireless communication device may receive a second configuration from the wireless communication node via a radio resource control (RRC) signaling. The second configuration may be indicative of a timer associated with a PRACH transmission, an operation for determining a TA related information, and/or a random access procedure. In some cases, at least one of: the timer starts when the wireless communication device performs a PRACH transmission in response to a network message indicative of a first PRACH transmission associated with a transmission parameter, an operation for determining a TA related information, or a random access procedure, and/or the timer restarts or resets when the wireless communication device receives a network message indicative of triggering a PRACH transmission associated with the timer and the timer is running or valid, or when the wireless communication device transmits a PRACH transmission associated with the timer and the timer is running or valid.

In some implementations, the wireless communication device may determine a transmission power of a PRACH transmission, according to at least one of: a target received power value configured by a radio resource control (RRC) signaling, a pathloss value determined according to a reference signal associated with the PRACH transmission or a network message, a power ramping value configured by the RRC signaling, or a counting value.

In some implementations, the wireless communication device can determine the counting value according to at least one of: (1) setting the counting value to an initial value, for the PRACH transmission, in response to a first network message indicative of a first PRACH transmission associated with a first transmission parameter, a operation for determining a timing advance value, or a random access procedure; (2) increasing the counting value by 1, for the PRACH transmission, in response to a second network message indicative of a first PRACH transmission associated with a first transmission parameter, a operation for determining a timing advance value, or a random access procedure, where the second network message may be received after the first network message; (3) increasing the counting value by 1, for the PRACH transmission in response to a third network message that is associated with a first transmission parameter, a operation for determining a timing advance value, or a random access procedure, wherein the third network message is received after the first network message; (4) not increasing the counting value or setting the counting value to a former value, if the wireless communication device has reached a maximum value (e.g., the maximum value of transmission power can be configured or predefined for a carrier component, a SRS resource set, a power class, a panel, and/a TCI state, etc.) of transmission power at a time instance (e.g., a transmission occasion, a slot, and/or a symbol, etc.) of the PRACH transmission; (5) setting the counting value to the initial value, if a timer associated with the PRACH transmission, the operation for determining a TA related information, or the random access procedure, expires; (6) setting the counting value to the initial value, if a timer associated with the PRACH transmission, the operation for determining a timing advance value, or the random access procedure, starts; (7) increasing the counting value by 1, if a timer associated with the PRACH transmission, the operation for determining a timing advance value or the random access procedure, restarts or resets; (8) setting the counting value to the initial value, if the PRACH transmission starts or ends at a symbol or slot later than a time duration from a starting or ending symbol of a previous PRACH transmission, or if the wireless communication device receives the network message associated with the PRACH transmission at a symbol or slot later than a time duration from a symbol or slot of receiving a network message associated with the previous PRACH transmission; and/or (9) resetting the counting value to the initial value, if the wireless device receives a network message specifying a specific value of a target received power for the PRACH transmission. In some cases, the time duration can be a predefined value, a RRC configured value, a fixed value, and/or a value based on the UE capability. The time duration may be in unit of a millisecond, symbol, slot, sub-slot, frame, or sub-frame, among others. The previous PRACH transmission may be associated with the same transmission parameter, timing advance acquisition procedure, and/or random access procedure as the PRACH transmission, for example.

In some configurations, the wireless communication device can determine a transmission power of a PRACH transmission, according to at least one of: a target received power value configured by a radio resource control (RRC) signaling, a pathloss value determined according to a reference signal associated with the PRACH transmission or a network message, a power ramping value configured by the RRC signaling, and/or an accumulation value of a transmission power ramping.

In various implementations, the wireless communication device can determine the accumulation value according to, using, or based on at least one of: (1) resetting the accumulation value to a defined value, if the PRACH transmission is a first PRACH transmission associated with a transmission parameter, a operation for determining a TA related information, or a random access procedure; (2) resetting the accumulation value to a defined value, if a timer associated with the PRACH transmission, the operation for determining a TA related information, or the random access procedure, expires; (3) resetting the accumulation value to a defined value, if a timer associated with the PRACH transmission, the operation for determining a TA related information, or the random access procedure, starts; (4) a transmission power or target received power of a previous PRACH transmission, if a timer associated with the PRACH transmission, the operation for determining a TA related information, or the random access procedure, restarts or resets; (5) a transmission power of a previous PRACH transmission, wherein the previous PRACH transmission is associated with a same transmission parameter, operation for determining a TA related information or the random access procedure, as the PRACH transmission; (6) an accumulated target received power of a previous PRACH transmission, wherein the accumulated target received power is determined based on a target received power value configured by a radio resource control (RRC) signaling and a power ramping value configured by the RRC signaling, wherein the previous PRACH transmission is associated with a same transmission parameter, operation for determining a TA related information or the random access procedure, as the PRACH transmission; (7) an accumulation value of PRACH transmission power ramping for a previous PRACH transmission, if UE has reached a maximum value of transmission power at a time instance of the PRACH transmission, wherein the previous PRACH transmission is associated with a same transmission parameter, operation for determining a TA related information or the random access procedure, as the PRACH transmission; (8) resetting the accumulation value to a defined value, if the PRACH transmission starts or ends at a symbol or slot later than a time duration from a starting or ending symbol of a previous PRACH transmission, or if the wireless communication device receives the network message associated with the PRACH transmission at a symbol or slot later than a time duration from a symbol or slot of receiving a network message associated with the previous PRACH transmission, wherein the previous PRACH transmission is associated with a same transmission parameter, operation for determining a TA related information or the random access procedure, as the PRACH transmission; and/or (9) resetting the accumulation value to a defined value, if the wireless communication device receives a network message specifying a specific value of a target received power for the PRACH transmission, wherein the wireless communication device determines a transmission power of the PRACH transmission based on the specific value of the target received power rather than a target received power value configured by RRC signaling. The maximum value of transmission power can be configured or predefined for a carrier component, an SRS resource set, a power class, a panel, and/or a TCI state, etc. The time instance can be a transmission occasion, a slot, or a symbol, among others. The time duration can be a predefined value, an RRC-configured value, a fixed value, and/or a value based on the UE capability, to name a few. The time duration can be in the unit of a millisecond, symbol, slot, sub-slot, frame, or sub-frame.

In some implementations, the transmission parameter can comprise/include at least one of: a candidate cell, a non-serving cell, a serving cell index different from one associated with a serving cell, a physical cell identifier (PCI) different from one associated with the serving cell, a timing advance group (TAG) associated with a specific control resource set (CORESET) pool index, a cell or transmission-reception point (TRP) not associated with Type-1 common search space (CSS), a TRP, a base station or wireless communication node, a set of panels of one base station, a cell, a physical cell, information grouping one or more reference signals, a reference signal resource set, a physical uplink control channel (PUCCH) resource set, a search space, panel related information, a sub-array, an antenna group, an antenna port group, a group of antenna ports, a beam group, a PCI, TRP related information, a CORESET, a CORESET pool, a transmission configuration indicator (TCI) state, a serving cell, an additional PCI, a candidate cell group, TAG, a UE capability value, and/or a UE capability set.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method comprising:
receiving, by a wireless communication device from a wireless communication node, a configuration for determining a timing advance (TA) related information between at least two possible approaches; and
performing, by the wireless communication device, at least one operation to determine the TA related information according to the configuration.

2. The method of claim 1, wherein the at least two possible approaches include: a first approach based on a physical random access channel (PRACH) transmission.

3. The method of claim 2, comprising:
receiving, by the wireless communication device, a network message that indicates switching to a transmission parameter; and at least one of:
applying, by the wireless communication device, a TA related information indicated by the network message, instead of the TA related information determined for the transmission parameter based on the second approach; or
applying, by the wireless communication device, the TA related information determined for the transmission parameter based on the second approach, when a TA related information is absent in the network message.

4. The method of claim 1, comprising:
determining, by the wireless communication device, that a plurality of PRACH transmissions are associated with a same operation for determining TA related information, responsive to: the plurality of PRACH transmissions are in response to network messages indicating a same cell indicator, and a same synchronization signal block (SSB) index.

5. The method of claim 1, comprising:
determining, by the wireless communication device, a transmission power of a PRACH transmission, according to at least one of: a target received power value configured by a radio resource control (RRC) signaling, a pathloss value determined according to a reference signal associated with the PRACH transmission or a network message, a power ramping value configured by the RRC signaling, or a counting value.

6. The method of claim 5, comprising:
determining, by the wireless communication device, the counting value according to at least one of:
(1) setting the counting value to an initial value, for the PRACH transmission, in response to a first network message indicative of a first PRACH transmission associated with a first transmission parameter; or
(2) increasing the counting value by 1, for the PRACH transmission, in response to a second network message indicative of a first PRACH transmission associated with a first transmission parameter, wherein the second network message is received after the first network message.

7. The method of claim 3, wherein the transmission parameter comprises: a candidate cell.

8. A wireless communication device, comprising:
at least one processor configured to:
receive, via a receiver from a wireless communication node, a configuration for determining a timing advance (TA) related information between at least two possible approaches; and
perform at least one operation to determine the TA related information according to the configuration.

9. The wireless communication device of claim 8, wherein the at least two possible approaches include: a first approach based on a physical random access channel (PRACH) transmission.

10. The wireless communication device of claim 9, comprising:
receiving, by the wireless communication device, a network message that indicates switching to a transmission parameter; and at least one of:
applying, by the wireless communication device, a TA related information indicated by the network message, instead of the TA related information determined for the transmission parameter based on the second approach; or
applying, by the wireless communication device, the TA related information determined for the transmission parameter based on the second approach, when a TA related information is absent in the network message.

11. The wireless communication device of claim 8, comprising:
determining, by the wireless communication device, that a plurality of PRACH transmissions are associated with a same operation for determining TA related information, responsive to: the plurality of PRACH transmissions are in response to network messages indicating a same cell indicator, and a same synchronization signal block (SSB) index.

12. The wireless communication device of claim 8, comprising:
determining, by the wireless communication device, a transmission power of a PRACH transmission, according to at least one of: a target received power value configured by a radio resource control (RRC) signaling, a pathloss value determined according to a reference signal associated with the PRACH transmission or a network message, a power ramping value configured by the RRC signaling, or a counting value.

13. The wireless communication device of claim 12, comprising:
determining, by the wireless communication device, the counting value according to at least one of:
(1) setting the counting value to an initial value, for the PRACH transmission, in response to a first network message indicative of a first PRACH transmission associated with a first transmission parameter; or
(2) increasing the counting value by 1, for the PRACH transmission, in response to a second network message indicative of a first PRACH transmission associated with a first transmission parameter, wherein the second network message is received after the first network message.

14. The wireless communication device of claim 10, wherein the transmission parameter comprises a candidate cell.

15. A method comprising:
sending, by a wireless communication node to a wireless communication device, a configuration for determining a timing advance (TA) related information between at least two possible approaches,
wherein the wireless communication device performs at least one operation to determine the TA related information according to the configuration.

16. The method of claim 15, wherein the at least two possible approaches include: a first approach based on a physical random access channel (PRACH) transmission.

17. The method of claim 15, comprising:
sending, by the wireless communication node to the wireless communication device, a network message that indicates switching to a transmission parameter, wherein the transmission parameter comprises a candidate cell.

18. A wireless communication node, comprising:
at least one processor configured to:
send, via a transmitter to a wireless communication device, a configuration for determining a timing advance (TA) related information between at least two possible approaches, wherein the wireless communication device performs at least one operation to determine the TA related information according to the configuration.

19. The wireless communication node of claim 18, wherein the at least two possible approaches include: a first approach based on a physical random access channel (PRACH) transmission.

20. The wireless communication node of claim 18, wherein the at least one processor is configured to:
send, via the transmitter to the wireless communication device, a network message that indicates switching to a transmission parameter, wherein the transmission parameter comprises a candidate cell.
